(19) United States
(12) Patent Application Publication
(10) Pub. No.: US 2025/0142659 A1
(43) Pub. Date: May 1, 2025

(54) METHOD, DEVICE AND COMPUTER STORAGE MEDIUM OF COMMUNICATION

(71) Applicant: NEC Corporation, Tokyo (JP)

(72) Inventors: Gang WANG, Beijing (CN); Peng GUAN, Beijing (CN); Yukai GAO, Beijing (CN)

(73) Assignee: NEC Corporation, Tokyo (JP)

(21) Appl. No.: 18/865,770

(22) PCT Filed: May 18, 2022
(86) PCT No.: PCT/CN2022/093531

§ 371 Date: Nov. 14, 2024

(51) Int. Cl. H04W 76/20; H04L 1/1812; H04W 74/0833

(52) U.S. Cl. CPC H04W 76/20; H04L 1/1812; H04W 74/0833

(57) ABSTRACT

Embodiments of the present disclosure relate to methods, devices and computer readable media of communication. A terminal device receives, from a network device, a first configuration information transmitted on a first cell, wherein the first configuration information includes a set of TCI states, and the set of TCI states is associated with a second cell different from the first cell. The terminal device receives a first activation command to activate one or more TCI states, wherein the one or more TCI states comprise at least one TCI state from the set of TCI states. The terminal device applies the one or more activated TCI states from a first slot after a predefined timing. In this way, a beam for the second cell can be indicated according to the TCI state indicated by the first cell before serving cell change; accordingly, the latency, the overhead and the interruption time during the inter-cell mobility can be reduced.

### TECHNICAL FIELD

Embodiments of the present disclosure generally relate to the field of telecommunication, and in particular, to methods, devices and computer storage media of communication for inter-cell mobility.

### BACKGROUND

In traditional cellular networks, each network device is associated with a coverage area or a cell. The network may maintain the communication between a serving cell and a terminal device in the cell until a handover (HO) procedure is triggered. Current solutions about UE mobility include intra-cell mobility and inter-cell mobility. Intra-cell mobility involves management of cell-specific communication resources and cell-specific configurations, in which the serving cell is not changed. In inter-cell mobility, also referred to as mobility management, a terminal device releases its link with a source cell and establishes a new link with a target cell. Conventional inter-cell mobility involves higher-layer signaling exchange between the terminal device and network equipment to achieve the change of serving cell, and thus has a long latency, a large overhead and a long interruption time. Thus, how to reduce the latency, the overhead and the interruption time during the inter-cell mobility is a problem to be solved.

### SUMMARY

In general, embodiments of the present disclosure provide methods, devices and computer storage media of communication for indicating a beam for the target cell for L1/L2-based inter-cell mobility.

In a first aspect, there is provided a communication method implemented at a terminal device. The method comprises: receiving, from a network device, a first configuration information transmitted on a first cell, wherein the first configuration information includes a set of transmission configuration indicator (TCI) states, and the set of TCI states is associated with a second cell different from the first cell; receiving a first activation command to activate one or more TCI states, wherein the one or more TCI states comprise at least one TCI state from the set of TCI states; and applying the one or more activated TCI states from a first slot after a predefined timing.

In a second aspect, there is provided a communication method implemented at a network device. The method comprises: transmitting, to a terminal device, a first configuration information on a first cell, wherein the first configuration information includes a set of TCI states, and the set of TCI states is associated with a second cell different from the first cell; transmitting a first activation command to activate one or more TCI states, wherein the one or more TCI states comprise at least one TCI state from the set of TCI states; and applying the one or more activated TCI states from a first slot after a predefined timing.

In a third aspect, there is provided a terminal device. The terminal device comprises a processor; and a memory coupled to the processor and storing instructions thereon, the instructions, when executed by the processor, causing the terminal device to perform acts comprising the method according to the first aspect of the present disclosure.

In a fourth aspect, there is provided a network device. The network device comprises a processor; and a memory coupled to the processor and storing instructions thereon, the instructions, when executed by the processor, causing the network device to perform acts comprising the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure or the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example environment in which some embodiments of the present disclosure can be implemented;

FIG. 2 illustrates a schematic diagram illustrating a process of communication according to some embodiments of the present disclosure;

FIG. 3 illustrates an example method of communication implemented at a terminal device in accordance with some embodiments of the present disclosure;

FIG. 4 illustrates an example method of communication implemented at a first network device in accordance with some embodiments of the present disclosure; and

FIG. 5 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of scheduling or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In the context of the present application, the term “PSCell” refers to a SpCell of a secondary cell group (SCG), the term “PCell” refers to a SpCell of a master cell group (MCG), and the term “SpCell” refers to a primary cell of a SCG or MCG. The term “SCell” refers to a secondary cell of a SCG or MCG.

In the context of the present application, the terms “TCI state(s) associated with a cell”, “TCI state(s) configured for a cell”, “TCI state(s) for a cell” and “TCI state(s) of a cell” can be used interchangeably and refer to TCI state(s) applied to the cell, or in other words, TCI state(s) applied to a UL/DL channel or signal in the cell.

In the context of the present application, the term “TCI state(s) for transmission in the cell” indicates that the TCI state(s) derives from the set of TCI states associated with the cell.

In the context of the present application, the term “L1” refers to a physical (PHY) layer. The term “L2” refers to a link layer, a data link layer, a medium access control (MAC) layer, a radio link control (RLC) layer, or a packet data convergence protocol (PDCP) layer. L2 implements communications protocols that use L1 PHY operations and physical addresses of nodes.

In the context of the present application, the term “inter-cell change”, “inter-cell mobility”, “switching of serving cell” and “serving cell change” refer to that the terminal device switches from cell A to cell B, that is, the terminal device will use or apply the relevant configuration of Cell B (such as the RRC configuration/parameter related to Cell B), which means that cell B will serve the terminal device (that is, the terminal device will communicate with cell B for interaction of control signaling and data information).

As mentioned above, how to reduce the latency, the overhead and the interruption time during the inter-cell mobility is a problem to be solved. One potential solution may be implemented in such a manner that the serving cell change may occur at the same time as the beam change or switch. For example, serving cell change and the beam change may be indicated simultaneously by a L1/L2 signaling or respectively but in a very short period of time by a L1/L2 signaling. In intra-cell mobility without serving cell change, beam change may be achieved in such a manner that a cell may indicate a set of TCI states to be applied to a channel or reference signal for a long time in the future, and a terminal device may switch beams autonomously according to orders and application time associated with TCI states in the indicated set of TCI states. However, since information about the QCL-TypeA RS (e.g., Doppler shift, Doppler spread, average delay, delay spread) configured in the TCI state cannot be not applied across cells, the indicated TCI state cannot be used in the target cell after serving cell change in L1/L2-based inter-cell mobility. There is no mechanism for indicating a beam for the target cell for L1/L2-based inter-cell mobility.

Embodiments of the present disclosure provide a solution for solving the above and other potential issues. In the solution, a terminal device receives, from a network device, a first configuration information transmitted on a first cell, wherein the first configuration information includes a set of TCI states, and the set of TCI states is associated with a second cell different from the first cell. The terminal device receives a first activation command to activate one or more TCI states, wherein the one or more TCI states comprise at least one TCI state from the set of TCI states. The terminal device applies the one or more activated TCI states from a first slot after a predefined timing. In this way, a beam for the second cell can be indicated according to the TCI state indicated by the first cell before serving cell change; accordingly, the latency, the overhead and the interruption time during the inter-cell mobility can be reduced.

Principles and implementations of the present disclosure will be described in detail below with reference to the figures.

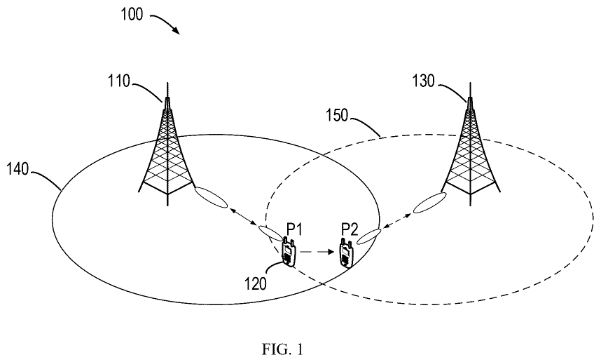

FIG. 1 illustrates an example environment 100 in which example embodiments of the present disclosure can be implemented. As shown in FIG. 1, the environment 100, which may be a part of a communication network, comprises a first network device 110, a terminal device 120 and a second network device 130. The first network device 110 may be a gNB, or a NetWork (NW) or a TRP, which schedules a first cell or a first bandwidth part (BWP) 140. The second network device 130 may be a gNB, or a NetWork (NW) or a TRP, which schedules a second cell or a second BWP 150.

As shown in FIG. 1, a communication link may be formed between the first cell 140 and the terminal device 120 located at the first position P1. When the terminal device 120 moves from the first position P1 to the second position P2, the terminal device 120 may measure the quality of the beam from the second cell 150 and provides a measurement report to the first network device 110 for determining whether to perform a HO procedure of the serving cell. When the quality of the beam from the second cell 150 is better, the first network device 110 may determine to hand over the terminal device 120 from the first cell 140 to the second cell 150. The first network device 110 and the first cell 140 may be referred to as a source network device and a source cell, respectively. The second network device 130 and the second cell 150 may be referred to as a target network device and a target cell, respectively.

It is to be understood that the above embodiment is given for the purpose of illustration without suggesting any limitations to the present disclosure. In some embodiments, the HO procedure of the serving cell may be triggered due to other reasons than the position movement of the terminal device, and may be determined by measuring other measurement parameters and based on other decision conditions.

The terminal device 120 may communicate with the source cell 140 or the target cell 150 via a channel such as a wireless communication channel. The communications in the environment 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

Communication in a direction from the terminal device 120 towards the source cell 140 or the target cell 150 is referred to as uplink (UL) communication, while communication in a reverse direction from the source cell 140 or the target cell 150 towards the terminal device 120 is referred to as downlink (DL) communication. The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH).

In some scenarios, the terminal device 120 may be pre-configured with a set of TCI states associated with the target cell 150. When it is determined to perform a HO procedure from the source cell 140 to the target cell 150, the source cell 140 may indicate one or more TCI states to the terminal device 120, wherein the one or more TCI states comprise at least one TCI state from the set of TCI states. The terminal device 120 may apply the at least one indicated TCI state in the target cell.

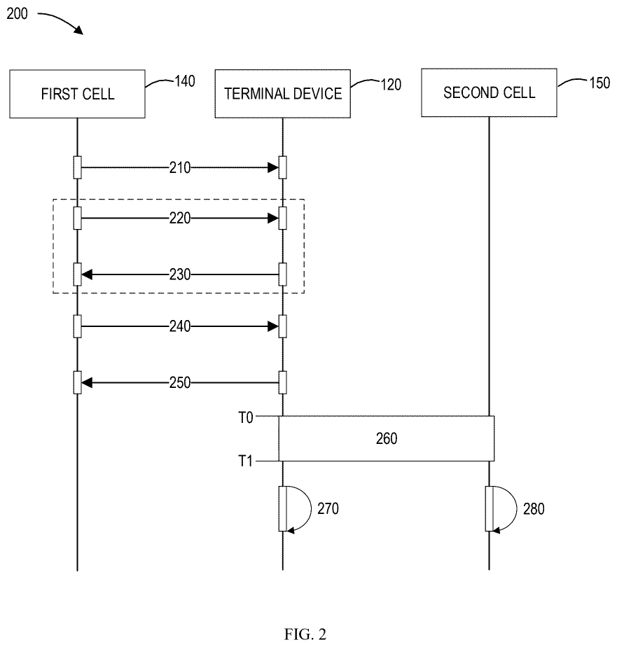

Embodiments of the present disclosure provide a solution of indicating a TCI state that can be applied for the target cell in L1/L2-based inter-cell mobility. The solution will be described in detail with reference to FIGS. 2 to 4 below.

FIG. 2 illustrates a schematic diagram illustrating a process 200 of communication according to some embodiments of the present disclosure. For the purpose of discussion, the process 200 will be described with reference to FIG. 1. The process 200 may involve the source cell 140, the terminal device 120 and the target cell 150 as illustrated in FIG. 1.

For the terminal device 120, the source cell 140 is associated with a first PCI and target cell 150 is associated with a second PCI different from the first PCI. In the context of the present application, the terms “PCI associated with a cell”, “PCI corresponding to a cell” and “PCI of a cell” can be used interchangeably and refer to a specific PCI assigned to the cell. And the PCI of the target cell is different from that of the source cell.

As shown in FIG. 2, the source cell 140 transmits (210), to the terminal device 120, a first configuration information including a set of TCI states, wherein the set of TCI states is associated with a target cell 150 different from the source cell 140.

In some embodiments, the source cell 140 may carry the first configuration information in a Radio Resource Control (RRC) signaling. The terminal device 120 may be configured with the set of TCI states associated with the target cell 150 based on the RRC.

In some embodiments, the terminal device 120 (e.g., supporting L1/L2-based mobility) may be configured with a list of up to M TCI states (TCI state pool). The TCI state pool for the target cell (also referred to as candidate cell) can be configured in another higher layer parameter different from the higher layer parameter PDSCH-Config. For example, an example implementation may be embodied as follows:
For L1/L2-based mobility, the UE can be configured with a list of up to [M] [TCI-state] configurations, within the higher layer parameter XXX, with [tci-StateId_r17] that include [SourceRs-Info_r17] for providing a reference signal for the quasi-colocation for DM-RS of PSDCH and DM-RS of PDCCH in a candidate cell, CSI-RS, and to provide a reference, if applicable, for determining UL TX spatial filter for dynamic-grant and configured-grant based PUSCH and PUCCH resource in a candidate cell, and SRS.

It should be noted, in the context of the present application, when the term “for L1/L2-based mobility” is present at the beginning of a sentence, the term “activation command” present in the sentence refers to an activation command for L1/L2-based mobility.

Optionally, the terminal device 120 may be further configured with the higher layer parameter PDSCH-Config. For example, an example implementation may be embodied as follows:
The UE can be configured with a list of up to [128] [TCI-state] configurations, within the higher layer parameter PDSCH-Config, with [tci-StateId_r17] that include [SourceRs-Info_r17] for providing a reference signal for the quasi-colocation for DM-RS of PSDCH and DM-RS of PDCCH in a CC or (a candidate cell), CSI-RS, and to provide a reference, if applicable, for determining UL TX spatial filter for dynamic-grant and configured-grant based PUSCH and PUCCH resource in a CC, and SRS. If the [TCI-state] configuration is absent in a BWP of the CC, the UE can apply the [TCI-state] configuration from a reference BWP of a reference CC.

In some embodiments, the TCI state for the target cell 150 may provide QCL-RS for PDCCH/PDSCH/CSI-RS in the target cell, spatial RS for PUSCH/PUCCH/SRS in the target cell, path loss RS (PL-RS) and UL power control information for PUSCH/PUCCH/SRS in the target cell.

The source cell 140 transmits (240), to the terminal device 120, a first activation command to activate one or more TCI states, wherein the one or more TCI states comprise at least one TCI state from the set of TCI states.

In some embodiments, the source cell 140 may carry the first control command in a medium access control (MAC) control element (CE) for mobility on a PDSCH to indicate the one or more TCI states. The terminal device 120 may be activated or indicated with at least one TCI state for the target cell based on MAC-CE for mobility. The UE may thus be dynamically indicated with a beam (i.e., TCI state) of the target cell.

In some embodiments, the terminal device 120 may receive the first activation command to activate the one or more TCI states and to activate a physical cell index (PCI) of the target cell 150 indicating that the at least one TCI state is for transmission in the target cell 150. For example, in addition to the one or more TCI states, the first activation command (e.g., MAC-CE for mobility) may activate or indicate at least one of the following information: serving cell index, additional PCI (i.e., PCI of the target cell) or HO information. The terminal device 120 can determine the application range of the MAC-CE for mobility and the indicated TCI state(s) according to these information. The serving cell index may be used to indicate which serving cell the MAC-CE for mobility is applied to. The HO information may include parameters about RA process or timing advance (TA).

In some embodiments, the terminal device 120 may receive the first activation command to activate one TCI state among the set of TCI states for transmission in the target cell 150. The first activation command (e.g., MAC-CE for mobility) may further an additional PCI that is used to indicate which cell the activated TCI state is applied to. The cell may be a PCell, a PSCell or a cell with a cell identifier (ID) equal to “0” corresponding to the additional PCI. For example, the terminal device 120 may be activated or indicated with a (joint or DL) TCI state that is used to be applied for DL (and UL) channels or signals in the target cell 150. An example implementation may be embodied as follows:
For L1/L2-based mobility, the UE receives an activation command, as described in clause 6.1.3.x of [10, TS 38.321], for one of the provided TCI states for the target cell.

In some embodiments, the terminal device 120 may receive the first activation command to activate two TCI states among the set of TCI states for UL transmission and DL transmission in the target cell 150, respectively. The first activation command (e.g., MAC-CE for mobility) may further an additional PCI that is used to indicate which cell the activated TCI states are applied to. For example, the terminal device 120 may be activated or indicated with DL TCI state and an UL TCI state, wherein the DL TCI state and the UL TCI state are used to be applied for DL and channels or signals respectively in the target cell 150.

An example implementation may be embodied as follows:
For L1/L2-based mobility, the UE receives an activation command, as described in clause 6.1.3.x of [10, TS 38.321], for two of the provided TCI states, with one TCI state for DL channels/signals and the second TCI state for UL channels/signals.

In some embodiments, the first activation command may comprise a DL information indicating that one of the two TCI states is for DL transmission (e.g., DL channels or signals) in the target cell 150; and an UL information indicating that the other of the two TCI states is for UL transmission (e.g., UL channels or signals) in the target cell 150. Alternatively, the correspondence between the two activated TCI states and the DL and UL transmissions can be implicitly determined, e.g., with TCI-StateId. For example, the first TCI state of the two indicated TCI states may be applied for DL transmission in the target cell 150; and the second TCI state of the two activated TCI states may be applied for UL transmission in the target cell 150, wherein the first TCI state and the second TCI state are determined based on an ascending order of TCI state identifier (i.e., TCI-StateId) of the two TCI states. In other words, the TCI state with the smallest TCI-StateId may be applied for DL transmission in the target cell 150 and the TCI state with the second smallest TCI-StateId may be applied for UL transmission in the target cell 150.

In some embodiments, the terminal device 120 may receive the first activation command to activate a first TCI state for transmission in the source cell 140 and to activate a second TCI state among the set of TCI states for transmission in the target cell 150. For example, the terminal device 120 may be activated or indicated with a (joint or DL) TCI state that is used to be applied for DL (and UL) channels or signals in the source cell 140 and a (joint or DL) TCI state that is used to be applied for DL (and UL) channels or signals in the target cell 150.

An example implementation may be embodied as follows:
For L1/L2-based mobility, the UE receives an activation command, as described in clause 6.1.3.x of [10, TS 38.321], for one of the provided TCI states for the serving cell, and one of the provided TCI states for the target cell.

In some embodiments, the first activation command may comprise: a cell index of the source cell 140 indicating that the first TCI state is for transmission in the source cell 140; and a PCI of the target cell 150 indicating that the second TCI state is for transmission in the target cell 150. Alternatively, the correspondence between the two activated TCI states and the transmissions in the source and target cells can be implicitly determined, e.g., with TCI-StateId. For example, the first TCI state for transmission in the source cell 140 and the second TCI state for transmission in the target cell 150 may be determined based on an ascending order of TCI state identifier (i.e., TCI-StateId) of the two TCI states. In other words, the TCI state with the smallest TCI-StateId may be applied for transmission in the source cell 140 and the TCI state with the second smallest TCI-StateId may be applied for transmission in the target cell 150. In some embodiments, the first activation command may comprise two indication information indicating which one of the two TCI states is applied for transmission in the source cell 140 and which one of the two TCI states is applied for transmission in the target cell 150.

In some embodiments, after the step 210, the source cell 140 may transmit (220), to the terminal device 120, a second activation command (e.g. MAC-CE) to activate a subset of TCI states among the set of TCI states associated with the target cell 150. Upon reception of the second activation command to indicate the subset of TCI states, the terminal device 120 may transmit (230), to the source cell 140, a PUCCH carrying a hybrid automatic repeat request (HARQ) information corresponding to the second activation command. The source cell 140 may then transmit (240), to the terminal device 120, the first activation command (e.g., MAC-CE for mobility) to activate the at least one TCI state among the subset of TCI states.

Upon reception of the first activation command, the terminal device 120 may transmit (250), to the source cell 140, a PUCCH carrying a HARQ information corresponding to the first activation command.

Assuming that a delay for the first control command to take effect is 3 ms. At a timing T0 after 3 ms after the PUCCH transmission carrying the HARQ information corresponding to the first activation command, the terminal device 120 performs (260) a serving cell change, i.e., a HO procedure. In some embodiments, the terminal device 120 needs to perform a random access (RA) process to obtain UL TA. In some embodiments, the terminal device 120 does not need to perform the RA process and the UL timing can be obtained by using other manners.

From a first slot after a predefined timing, the terminal device 120 applies (270) the one or more activated TCI states. In this way, a beam for the target cell 150 can be indicated according to the TCI state indicated by the source cell 140 before serving cell change and the indicated TCI state associated with the target cell 150 may be applied in the target cell 150 after the serving cell change is completed.

It is to be understood that the timing of the signaling process of FIG. 2 is shown only for ease of illustration and is not intended to be limiting. For example, the timing of step 270 may occur before the step 260 is completed or after the step 260 is completed. In other words, the terminal device 120 may apply the one or more activated TCI states from a first slot after the serving cell change is completed (i.e., after T1) or during the process of the serving cell change (i.e. from T0 to T1). Accordingly, the terminal device 120 knows about when to apply the activated TCI state(s) for the target cell.

In some embodiments, the predefined timing may comprise a first timing when the RA procedure is completed successfully in the target cell 150. In some examples, the RA procedure may be performed to obtain a new UL TA for the target cell 150. Therefore, “serving cell change is completed” can be represented by “RA procedure is completed successfully”. For example, the first timing may comprise a timing when the terminal device 120 transmits, to the target cell 150, a HARQ-ACK information in a PUCCH transmission corresponding to a PDSCH carrying a terminal device contention resolution identity (e.g., Contention Based Random Access (CBRA)) or a random access response (RAR) message (e.g., Non Contention or Contention Free Random Access (CFRA)). Alternatively, the first timing may comprise a timing when the terminal device 120 receives, from the target cell 150, a PDCCH carrying a RAR message.

In some embodiments, the terminal device 120 does not need to perform the RA process and the UL timing can be obtained based on some predefined criteria or the implementation at the terminal device 120. The predefined timing may comprise a second timing associated with the terminal device receiving a PDCCH/PDSCH transmission addressed to a cell-radio network temporary identifier (C-RNTI). The C-RNTI may be a new C-RNTI that is different from the existing/current C-RNTI. For example, the second timing may comprise a timing when the terminal device 120 receives, from the target cell 150, the PDCCH/PDSCH transmission addressed to the C-RNTI. Alternatively, the second timing may comprise a timing when the terminal device 120 transmits, to the target cell 150, a PUSCH transmission scheduled by the PDCCH transmission addressed to the C-RNTI or a timing when the terminal device 120 transmits, to the target cell 150, a HARQ information corresponding to the PDSCH transmission addressed to the C-RNTI.

In some embodiments, the predefined timing may comprise a third timing when the terminal device transmits a physical uplink control channel (PUCCH) carrying a channel state information (CSI) report in the target cell 150. The “serving cell change is completed” may be reflected in that the terminal device has completed at least one CSI report in the target cell. Specifically, the CSI report may be triggered by a PDCCH/PDSCH transmitted from the target cell. In the context of the present application, the term “CSI report in the target cell” indicates at least one of: the CSI report carrying L1-RSRP/L1-SINR, or not carrying L1-RSRP/L1-SINR; the CSI resources (e.g., CSI-RS/SSB resource) associated with the CSI report being configured in the target cell (i.e., the CSI resources being associated with the PCI); the CSI report being triggered by a PDCCH/PDSCH with CRC scrambled by a new RNTI corresponding to the target cell (e.g., C-RNTI of the target cell that is different from the C-RNTI of the source cell).

In some embodiments, the predefined timing may comprise the second timing or the third timing if the terminal device 120 reports a first capability that the terminal device 120 does not need to perform the RA procedure; and the predefined timing may comprise the first timing if the first capability is not reported.

In some embodiments, the predefined timing may comprise the second timing or the third timing if the terminal device 120 is configured with a first configuration (e.g., “disableRandomAccess”) that the terminal device 120 does not need to perform the RA procedure or if the terminal device 120 is not configured with a second configuration (e.g., “enableRandomAccess”) that the terminal device 120 does not need to perform the RA procedure. The predefined timing may comprise the first timing if the terminal device 120 is not configured with the first configuration or if the terminal device 120 is configured with the second configuration.

In some embodiments, the predefined timing may comprise a fourth timing during the RA procedure in the target cell 150. The terminal device 120 needs to receive DL channels or signals transmitted from the target cell 150 and/or to transmit UL channels or signals to the target cell 150 before serving cell change is completed. For example, during serving cell change (e.g., RA process), PDCCH and PDSCH transmission may be necessary. In some embodiments, beams for PDCCH and PDSCH transmission may be determined based on the SSB applied for PRACH transmission. In order to improve the reliability of these DL/UL transmissions, the terminal device 120 may apply the activated TCI states before serving cell change is completed. For example, the terminal device 120 may transmit the RA preamble (Msg1) in a PRACH to the target cell 150, or the terminal device 120 may receive an RAR message with a PDCCH/PDSCH (Msg2) from the target cell 150, or the terminal device 120 may transmit a PUSCH scheduled by a RAR UL grant to the target cell 150.

In some embodiments, the predefined timing may comprise a fifth timing after a predefined duration after the terminal device 120 transmits a HARQ information (e.g., HARQ-ACK/NACK) in a PUCCH transmission corresponding to the first activation control command. The predefined duration may be configured by the source cell 140 and depends on a capability reported by the terminal device 120. For example, the predefined duration may refer to the time required for the terminal device 120 to process the first activation command, e.g., 3 ms for processing a MAC-CE for mobility. The activated TCI state may be applied after T0.

In embodiments where the terminal device 120 receives the first activation command to activate one TCI state among the set of TCI states for transmission in the target cell 150, the activated TCI state may be applied from a first slot after one timing among the first to fifth timings.

An example implementation may be embodied as follows:
For L1/L2-based mobility, the activated [TCI-State] configured with [tci-StateId_r17] should be applied starting from the first slot that is after serving cell change.

For example,
For L1/L2-based mobility, the activated [TCI-State] configured with [tci-StateId_r17] should be applied starting from the first slot that is after the last symbol of a PDCCH or PDSCH transmission to a C-RNTI.

Optionally, an example implementation may be embodied as follows:
For L1/L2-based mobility, when the UE would transmit a PUCCH with HARQ-ACK information in slot n corresponding to the PDSCH carrying the activation command, the activated [TCI-State] configured with [tci-StateId_r17] should be applied starting from the first slot that is at least m symbols after slot n+3Nₛₗₒₜ^{subframe.μ} where μ is the SCS configuration for the PUCCH.

wherein the “m symbols” may be configured by the source network device or source cell through RRC/MAC-CE and depends on a capability reported by the terminal device. For example, the “m symbols” may refer to the time required for serving cell change (e.g., RA process).

An example implementation may be embodied as follows:
For L1/L2-based mobility, when the UE would transmit a PUCCH with HARQ-ACK information in slot n corresponding to the PDSCH carrying the activation command, the activated [TCI-State] configured with [tci-StateId_r17] should be applied starting from the first slot that is after slot n+3Nₛₗₒₜ^{subframe.μ} where μ is the SCS configuration for the PUCCH.

In embodiments where the terminal device 120 receives the first activation command to activate two TCI states among the set of TCI states for UL transmission and DL transmission in the target cell 150, respectively, the two activated TCI state may be applied simultaneously from the first slot after one timing among the first to fifth timings.

An example implementation may be embodied as follows:
For L1/L2-based mobility, the activated [TCI-State] configured with [tci-StateId_r17] for DL/UL only should be applied starting from the first slot that is after serving cell change.

Alternatively, in embodiments where the first activation command is transmitted to activate two TCI states among the set of TCI states for UL transmission and DL transmission in the target cell 150, respectively, the two activated TCI state may be applied from different timings among the first to fifth timings. Since the terminal device 120 may not obtain the UL timing applied to the UL transmission to the target cell 150 before serving cell change is completed, the activated TCI state for UL transmission can not be applied before serving cell change is completed. Accordingly, the activated TCI state for DL transmission may be applied starting from before serving cell change is completed, and the activated TCI state for UL transmission may be applied starting from when serving cell change is completed. For example, the activated TCI state for DL transmission may be applied from the first slot after the first type of predefined timing selected among the fourth timing and the fifth timing, and the activated TCI state for UL transmission may be applied from the first slot after the second type of predefined timing selected among the first to the third timings.

An example implementation may be embodied as follows:
For L1/L2-based mobility, when the UE would transmit a PUCCH with HARQ-ACK information in slot n corresponding to the PDSCH carrying the activation command, the activated [TCI-State] configured with [tci-StateId_r17] for DL only should be applied starting from the first slot that is after slot n+3Nₛₗₒₜ^{subframe.μ} where μ is the SCS configuration for the PUCCH, the activated [TCI-State] configured with [tci-StateId_r17] for UL only should be applied starting from the first slot that is at least m symbols after slot n+3Nₛₗₒₜ^{subframe.μ} where μ is the SCS configuration for the PUCCH.

In embodiments where the terminal device 120 receives the first activation command to activate a first TCI state for transmission in the source cell 140 and to activate a second TCI state among the set of TCI states for transmission in the target cell 150, the two activated TCI state may be applied from different timings among the first to fifth timings. Accordingly, terminal device 120 knows about when to apply the activated TCI state for the source cell (represented by “sTCI state” for short hereafter) and when to apply the other activated TCI state for the target cell (represented by “tTCI state” for short hereafter). The activated sTCI state may be applied from the first slot after the first type of predefined timing until the second type of predefined timing, and the activated tTCI state may be applied from the first slot after the second type of predefined timing. The first type of predefined timing may comprise the fifth timing and the second type of predefined timing may comprise selected among the first to the fourth timings. For example, the activated sTCI state may be applied in the source cell 140 from T0 until the timing when serving cell change is completed (i.e., T1); and the activated tTCI state may be applied in the target cell 150 from T1. In other words, the terminal device 120 may stop applying the activated sTCI state from T1. In the context of the present application, the term “stop” can be used interchangeably with the term “terminate” or “suspend”.

An example implementation where the activated sTCI state is applied from the fifth timing and the activated tTCI state is applied from the first timing may comprise embodied as follows:
For L1/L2-based mobility, when the UE would transmit a PUCCH with HARQ-ACK information in slot n corresponding to the PDSCH carrying the activation command, the activated [TCI-State] configured with [tci-StateId_r17] for the serving cell should be applied starting from the first slot that is after slot n+3Nₛₗₒₜ^{subframe.μ} where μ is the SCS configuration for the PUCCH, the activated [TCI-State] configured with [tci-StateId_r17] for the target cell should be applied starting from the first slot that is at least m symbols after slot n+3Nₛₗₒₜ^{subframe.μ} where μ is the SCS configuration for the PUCCH.

Another example implementation where the activated sTCI state is applied from the fifth timing to the first timing and the activated tTCI state is applied from the first timing may comprise embodied as follows:
For L1/L2-based mobility, when the UE would transmit a PUCCH with HARQ-ACK information in slot n corresponding to the PDSCH carrying the activation command, the activated [TCI-State] configured with [tci-StateId_r17] for the serving cell should be applied starting from the first slot that is after slot n+3Nₛₗₒₜ^{subframe.μ} where μ is the SCS configuration for the PUCCH to the first slot that is at least m symbols after slot n+3Nₛₗₒₜ^{subframe.μ} where μ is the SCS configuration for the PUCCH, the activated [TCI-State] configured with [tci-StateId_r17] for the target cell should be applied starting from the first slot that is at least m symbols after slot n+3Nₛₗₒₜ^{subframe.μ} where μ is the SCS configuration for the PUCCH.

In some scenarios, before receiving the first activation command (e.g., MAC-CE for mobility) to activate the at least one second TCI state for transmission in the target cell 150, the terminal device 120 may have received a third activation command (e.g., MAC-CE) to activate at least one first TCI state for transmission in the source cell 140 or a first control command (e.g., DCI) to indicate at least one first TCI state for transmission in the source cell 140. The at least one first TCI state for transmission in the source cell 140 derives from the TCI state pool for the source cell and the at least one second TCI state for transmission in the target cell 150 derives from the TCI state pool for the target cell. The TCI state pool for the source cell is different from the TCI state pool for the target cell. After the terminal device 120 receives the first activation command, the third activation command or the first control command becomes invalid, thus avoiding conflicts between the first activation and the third activation command or conflicts between the first activation and the first control command.

In some embodiments, in response to receiving the first activation command, the terminal device 120 deactivates the third activation command. The third activation command was received to activate at least one first TCI state for transmission in the source cell 140 and was received no later than the first activation command. The terminal device 120 may deactivate the third activation command starting from one timing among the first to fifth timings.

For example, an example implementation in which the third activation command is deactivated when the first activation command is received may be embodied as follows:
When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after slot n+3Nₛₗₒₜ^{subframe.μ} where μ is the SCS configuration for the PUCCH. If tci-PresentInDCI is set to ‘enabled’ or tci-PresentDCI-1-2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the SS/PBCH block determined in the initial access procedure with respect to qcl-Type set to ‘typeA’, and when applicable, also with respect to qcl-Type set to ‘typeD’. When the UE would transmit a PUCCH with HARQ-ACK information in slot n corresponding to the PDSCH carrying an activation command for L1/L2 mobility, the activation command (only indicating TCI states) or the TCI states activated by the activation command should be deactivated or the indicated mapping between TCI states and codepoints of the DCI field ‘Transmission Configuration Indication’ should be stopped applying starting from the first slot that is after slot n+3Nₛₗₒₜ^{subframe.μ} where μ is the SCS configuration for the PUCCH.

In some embodiments, in response to receiving the first activation command, the terminal device 120 stopping applying at least one first TCI state for transmission in the source cell 140, wherein the at least one first TCI state is indicated by a first control command which was received no later than the first activation command. The terminal device 120 may stop applying at least one first TCI state indicated by the first control command starting from one timing among the first to fifth timings.

For example, an example implementation in which applying of the TCI state indicated by the first control command is stopped or the TCI field in the first control command is omitted when the first activation command is received may be embodied as follows:
When the UE would transmit the last symbol of a PUCCH with HARQ-ACK information corresponding to the DCI carrying the TCI-State indication and without DL assignment, or corresponding to the PDSCH scheduling by the DCI carrying the TCI-State indication, and if the indicated TCI-State is different from the previously indicated one, the indicated [TCI-State] with [tci-StateId_r17] should be applied starting from the first slot that is at least BeamAppTime_r17 symbols after the last symbol of the PUCCH. The first slot and the BeamAppTime_r17 symbols are both determined on the carrier with the smallest SCS among the carrier(s) applying the beam indication. The UE can assume one indicated [TCI-State] with [tci-StateId_r17] for DL and UL, for DL only, or for UL only at a time. When the UE would transmit a PUCCH with HARQ-ACK information in slot n corresponding to the PDSCH carrying an activation command for L1/L2 mobility, the UE stops applying the indicated [TCI-State] with [tci-StateId_r17] starting from the first slot that is after slot n+3Nₛₗₒₜ^{subframe.μ} where μ is the SCS configuration for the PUCCH.

In some embodiments, in response to receiving the first activation command, the terminal device 120 omits a TCI field in the first control command until the first timing when a RA procedure is completed successfully in the target cell 150 or the second timing associated with the terminal device receiving a PDCCH/PDSCH transmission addressed to a C-RNTI. In other words, the TCI field in the first control command is omitted starting from the timing when the first activation is received until the timing when the serving cell change is completed.

For example, an example implementation in which applying of the TCI state indicated by the first control command is stopped or the TCI field in the first control command is omitted when the first activation command is received may be embodied as follows:
The UE with activated [TCI-state] configured with [tci-StateId_r17] receives DCI format 1_1/1_2 providing indicated TCI-state with [tci-StateId_r17] for a CC or all CCs in the same CC list configured by [simultaneousTCI-UpdateList1 or simultaneousTCI-UpdateList2]. The DCI format 1_1/1_2 can be with or without, if applicable, DL assignment. If the DCI format 1_1/1_2 is without DL assignment, the UE can assume the following:
   CS-RNTI is used to scramble the CRC for the DCI.
   The values of the following DCI fields are set as follows:
      RV=all ‘1’s
      MCS=all ‘0’s
      NDI=0
      Set to all ‘0’s for FDRA Type 0, or all ‘1’s for FDRA Type 1, or all ‘0’s for dynamicSwitch.
When the UE would transmit a PUCCH with HARQ-ACK information in slot n corresponding to the PDSCH carrying an activation command for L1/L2 mobility, the UE omits TCI field in the DCI starting from the first slot that is after slot n+3Nₛₗₒₜ^{subframe.μ} where μ is the SCS configuration for the PUCCH to RA procedure is completed successfully.

In some embodiments, if the terminal device 120 is not provided or configured with the list up to M TCI states for the target cell (i.e., TCI state pool for target cell) by an RRC signaling, the terminal device 120 does not expect to receive a MAC-CE indicating a TCI state for the target cell, or a MAC-CE for mobility.

In some embodiments, the target cell 150 may receive a first configuration information configured on the source cell 140. The first configuration information includes a set of TCI states associated with a target cell 150 different from the source cell 140. The target cell 150 may receive a first activation information to activate at least one TCI state among the set of TCI states.

From a first slot after a predefined timing, the target cell 150 applies (280) the at least one TCI state.

In this way, a beam for the target cell 150 can be indicated according to the TCI state indicated by the source cell 140 before serving cell change; accordingly, the latency, the overhead and the interruption time during the inter-cell mobility can be reduced.

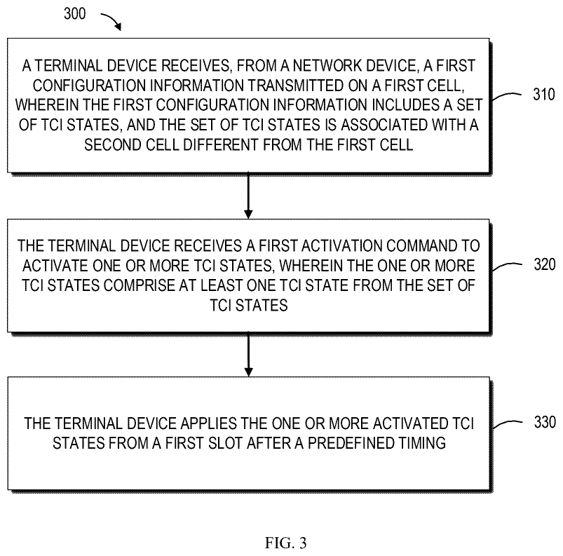

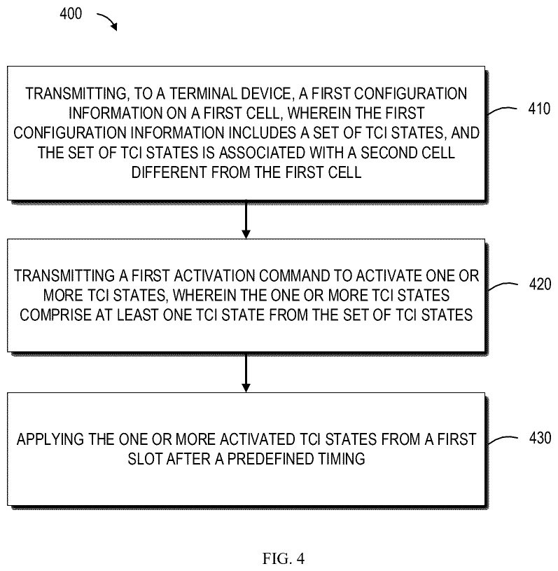

Accordingly, embodiments of the present disclosure provide methods of communication implemented at a terminal device and a first network device. These methods will be described below with reference to FIGS. 3 to 4.

FIG. 3 illustrates an example method 300 of communication implemented at a terminal device in accordance with some embodiments of the present disclosure. For the purpose of discussion, the method 300 will be described with reference to FIG. 1. It is to be understood that the method 300 may include additional blocks not shown and/or may omit some blocks as shown, and the scope of the present disclosure is not limited in this regard.

At block 310, the terminal device 120 receives, from the first network device 110, a first configuration information transmitted on a source cell 140, wherein the first configuration information includes a set of TCI states, and the set of TCI states is associated with a target cell 150 different from the source cell 140.

At block 320, the terminal device 120 receives a first activation command to activate one or more TCI states, wherein the one or more TCI states comprise at least one TCI state from the set of TCI states.

At block 320, the terminal device 120 applies the one or more activated TCI states from a first slot after a predefined timing.

In some embodiments, the terminal device 120 receives the first activation command to activate one TCI state among the set of TCI states for transmission in the target cell 150.

In some embodiments, the terminal device 120 receives the first activation command to activate two TCI states among the set of TCI states for uplink transmission and downlink transmission in the target cell 150, respectively.

In some embodiments, the first activation command comprises: a downlink information indicating that one of the two TCI states is for downlink transmission in the target cell 150; and an uplink information indicating that the other of the two TCI states is for uplink transmission in the target cell 150.

In some embodiments, a first TCI state of the two TCI states is for downlink transmission in the target cell 150; and a second TCI state of the two TCI states is for uplink transmission in the target cell 150. the first TCI state and the second TCI state are determined based on an ascending order of TCI state ID of the two TCI states.

In some embodiments, the terminal device 120 applies the two activated TCI states simultaneously from the first slot after the predefined timing; or applies one of the two activated TCI states for downlink transmission from the first slot after a first type of predefined timing and applying the other of the two activated TCI states for uplink transmission from the first slot after a second type of predefined timing. The first type of predefined timing comprises one of: a timing during a RA procedure; and a timing after a predefined duration after the terminal device transmits a HARQ information corresponding to the first activation command. The second type of predefined timing comprises one of: a timing when the RA procedure is completed successfully in the target cell 150; a timing associated with the terminal device receiving a PDCCH/PDSCH transmission addressed to a C-RNTI; and a timing when the terminal device transmits a PUCCH carrying a CSI report of the target cell 150.

In some embodiments, the terminal device 120 receives the first activation command to activate a first TCI state for transmission in the source cell 140 and to activate a second TCI state among the set of TCI states for transmission in the target cell 150.

In some embodiments, the first activation command comprises: a cell index of the source cell 140 indicating that the first TCI state is for transmission in the source cell 140; and a PCI of the target cell 150 indicating that the second TCI state is for transmission in the target cell 150.

In some embodiments, the first TCI state for transmission in the source cell 140 and the second TCI state for transmission in the target cell 150 are determined based on an ascending order of TCI state ID of the two TCI states.

In some embodiments, the terminal device 120 applies the first TCI state for transmission in the source cell 140 from the first slot after a first type of predefined timing until a second type of predefined timing; and applies the second TCI state for transmission in the target cell 150 from the first slot after the second type of predefined timing. The first type of predefined timing comprises a timing after a predefined duration after the terminal device transmits a HARQ information corresponding to the first activation command. The second type of predefined timing comprises one of: a timing when the RA procedure is completed successfully in the target cell 150; a timing associated with the terminal device receiving a PDCCH/PDSCH transmission addressed to a C-RNTI; a timing when the terminal device transmits a PUCCH carrying a CSI report of the target cell 150; and a timing during a RA procedure.

In some embodiments, the terminal device 120 receives the first activation command to activate the one or more TCI states and to activate a PCI of the target cell 150 indicating that the at least one TCI state is for transmission in the target cell 150.

In some embodiments, the terminal device 120 receives a second activation command to activate a subset of TCI states among the set of TCI states. The terminal device 120 receives the first activation command to activate the at least one TCI state among the subset of TCI states.

In some embodiments, in response to receiving the first activation command, the terminal device 120 deactivates a third activation command, wherein the third activation command activates at least one first TCI state for transmission in the source cell 140 and was received no later than the first activation command

In some embodiments, in response to receiving the first activation command, the terminal device 120 stops applying at least one first TCI state for transmission in the source cell 140, wherein the at least one first TCI state is indicated by a first control command which was received no later than the first activation command.

In some embodiments, in response to receiving the first activation command, the terminal device 120 omits a TCI field in a first control command until a first timing when a RA procedure is completed successfully in the target cell 150 or a second timing associated with the terminal device receiving a PDCCH/PDSCH transmission addressed to a C-RNTI.

In some embodiments, the predefined timing comprises at least one of: a first timing when a RA procedure is completed successfully in the target cell 150; a second timing associated with the terminal device receiving a PDCCH/PDSCH transmission addressed to a C-RNTI; a third timing when the terminal device transmits a PUCCH carrying a CSI report of the target cell 150; a fourth timing during the RA procedure; or a fifth timing after a predefined duration after the terminal device transmits a HARQ information corresponding to the first activation command.

In some embodiments, the predefined timing comprises the second timing or the third timing if the terminal device reports a first capability that the terminal device does not need to perform the RA procedure; and the predefined timing comprises the first timing if the first capability is not reported.

In some embodiments, the predefined timing comprises the second timing or the third timing if the terminal device is configured with a first configuration that the terminal device does not need to perform the RA procedure or if the terminal device is not configured with a second configuration that the terminal device needs to perform the RA procedure; and the predefined timing comprises the first timing if the terminal device is not configured with the first configuration or if the terminal device is configured with the second configuration.

In some embodiments, the second timing comprises one of: a timing when the terminal device receives the PDCCH/PDSCH transmission addressed to the C-RNTI; a timing when the terminal device transmits a PUSCH transmission scheduled by the PDCCH transmission addressed to the C-RNTI; and a timing when the terminal device transmits a HARQ information corresponding to the PDSCH transmission addressed to the C-RNTI.

With the method 300, a beam for the target cell 150 can be indicated according to the TCI state indicated by the source cell 140 before serving cell change. The terminal device 120 may apply the TCI state in the target cell 150 before or after the serving cell change is completed. Other details are similar with that described in connection with FIG. 2 and thus are not repeated here for concise.

FIG. 4 illustrates an example method 400 of communication implemented at a first network device in accordance with some embodiments of the present disclosure. For example, the method 400 may be performed at the source cell 140 as shown in FIG. 1. For the purpose of discussion, in the following, the method 400 will be described with reference to FIG. 1. It is to be understood that the method 400 may include additional blocks not shown and/or may omit some blocks as shown, and the scope of the present disclosure is not limited in this regard.

As shown in FIG. 4, at block 410, the first network device 110 transmits, to the terminal device 120, a first configuration information on a source cell 140. The first configuration information includes a set of TCI states. The set of TCI states is associated with a target cell 150 different from the source cell 140.

At block 420, the first network device 110 transmits a first activation command to activate one or more TCI states, wherein the one or more TCI states comprise at least one TCI state from the set of TCI states.

In some embodiments, the first network device 110 transmits a second activation command to activate a subset of TCI states among the set of TCI states. The source cell 140 transmits the first activation command to activate the at least one TCI state among the subset of TCI states.

At block 430, the one or more TCI states are applied in the source cell 140 and/or in the target cell 150 from a first slot after a predefined timing.

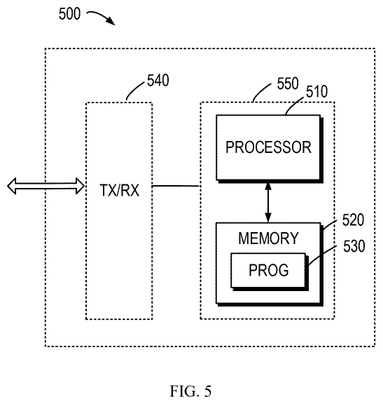

FIG. 5 is a simplified block diagram of a device 500 that is suitable for implementing embodiments of the present disclosure. The device 500 can be considered as a further example implementation of the first network device 110, the terminal device 120 or the second network device 130 as shown in FIG. 1. Accordingly, the device 500 can be implemented at or as at least a part of the first network device 110, the terminal device 120 or the second network device 130.

As shown, the device 500 includes a processor 510, a memory 520 coupled to the processor 510, a suitable transmitter (TX) and receiver (RX) 540 coupled to the processor 510, and a communication interface coupled to the TX/RX 540. The memory 510 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 530 is assumed to include program instructions that, when executed by the associated processor 510, enable the device 500 to operate in accordance with the embodiments of the present disclosure, as discussed herein with reference to FIGS. 1 to 4. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means 550 adapted to implement various embodiments of the present disclosure.

The memory 520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

In some embodiments, a terminal device comprises circuitry configured to perform method 300.

In some embodiments, a network device comprises circuitry configured to perform method 400.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

The embodiments may further be implemented in the following aspects.

In a first aspect, there is provided a communication method implemented at a terminal device. The communication method comprises: receiving, from a network device, a first configuration information transmitted on a first cell, wherein the first configuration information includes a set of transmission configuration indicator (TCI) states, and the set of TCI states is associated with a second cell different from the first cell; receiving a first activation command to activate one or more TCI states, wherein the one or more TCI states comprise at least one TCI state from the set of TCI states; and applying the one or more activated TCI states from a first slot after a predefined timing.

In some examples, receiving the first activation command comprises: receiving the first activation command to activate one TCI state among the set of TCI states for transmission in the second cell.

In some examples, receiving the first activation command comprises: receiving the first activation command to activate two TCI states among the set of TCI states for uplink transmission and downlink transmission in the second cell, respectively.

In some examples, the first activation command comprises: a downlink information indicating that one of the two TCI states is for downlink transmission in the second cell; and an uplink information indicating that the other of the two TCI states is for uplink transmission in the second cell.

In some examples, a first TCI state of the two TCI states is for downlink transmission in the second cell; and a second TCI state of the two TCI states is for uplink transmission in the second cell; wherein the first TCI state and the second TCI state are determined based on an ascending order of TCI state ID of the two TCI states.

In some examples, applying the one or more activated TCI states comprises one of: applying the two activated TCI states simultaneously from the first slot after the predefined timing; and applying one of the two activated TCI states for downlink transmission from the first slot after a first type of predefined timing and applying the other of the two activated TCI states for uplink transmission from the first slot after a second type of predefined timing. The first type of predefined timing comprises one of: a timing during a RA procedure; and a timing after a predefined duration after the terminal device transmits a HARQ information corresponding to the first activation command. The second type of predefined timing comprises one of: a timing when the RA procedure is completed successfully in the second cell; a timing associated with the terminal device receiving a PDCCH/PDSCH transmission addressed to a C-RNTI; and a timing when the terminal device transmits a PUCCH carrying a CSI report of the second cell.

In some examples, receiving the first activation command comprises: receiving the first activation command to activate a first TCI state for transmission in the first cell and to activate a second TCI state among the set of TCI states for transmission in the second cell,. The first activation command comprises: a cell index of the first cell indicating that the first TCI state is for transmission in the first cell; and a PCI of the second cell indicating that the second TCI state is for transmission in the second cell.

In some examples, receiving the first activation command comprises: receiving the first activation command to activate a first TCI state for transmission in the first cell and to activate a second TCI state among the set of TCI states for transmission in the second cell, wherein the first TCI state and the second TCI state are determined based on an ascending order of TCI state ID of the two TCI states.

In some examples, applying the one or more activated TCI states comprises: applying the first TCI state for transmission in the first cell from the first slot after a first type of predefined timing until a second type of predefined timing; and applying the second TCI state for transmission in the second cell from the first slot after the second type of predefined timing. The first type of predefined timing comprises a timing after a predefined duration after the terminal device transmits a HARQ information corresponding to the first activation command. The second type of predefined timing comprises one of: a timing when the RA procedure is completed successfully in the second cell; a timing associated with the terminal device receiving a PDCCH/PDSCH transmission addressed to a C-RNTI; a timing when the terminal device transmits a PUCCH carrying a CSI report of the second cell; and a timing during a RA procedure.

In some examples, receiving the first activation command comprises: receiving the first activation command to activate the one or more TCI states and to activate a PCI of the second cell indicating that the at least one TCI state is for transmission in the second cell.

In some examples, the method further comprises receiving a second activation command to activate a subset of TCI states among the set of TCI states; and wherein receiving the first activation command comprises receiving the first activation command to activate the at least one TCI state among the subset of TCI states.

In some examples, the method further comprises in response to receiving the first activation command, deactivating a third activation command, wherein the third activation command activates at least one first TCI state for transmission in the first cell and was received no later than the first activation command.

In some examples, the method further comprises in response to receiving the first activation command, stopping applying at least one first TCI state for transmission in the first cell, wherein the at least one first TCI state is indicated by a first control command which was received no later than the first activation command.

In some examples, the method further comprises in response to receiving the first activation command, omitting a TCI field in a first control command until a first timing when a RA procedure is completed successfully in the second cell or a second timing associated with the terminal device receiving a PDCCH/PDSCH transmission addressed to a C-RNTI.

In some examples, the predefined timing comprises at least one of: a first timing when a RA procedure is completed successfully in the second cell; a second timing associated with the terminal device receiving a PDCCH/PDSCH transmission addressed to a C-RNTI; a third timing when the terminal device transmits a PUCCH carrying a CSI report of the second cell; a fourth timing during the RA procedure; or a fifth timing after a predefined duration after the terminal device transmits a HARQ information corresponding to the first activation command.

In some examples, the predefined timing comprises the second timing or the third timing if: the terminal device reports a first capability that the terminal device does not need to perform the RA procedure, or the terminal device is configured with a first configuration that the terminal device does not need to perform the RA procedure, or the terminal device is not configured with a second configuration that the terminal device needs to perform the RA procedure. The predefined timing comprises the first timing if: the first capability is not reported, or the terminal device is not configured with the first configuration, or the terminal device is configured with the second configuration.

In some examples, the second timing comprises one of: a timing when the terminal device receives the PDCCH/PDSCH transmission addressed to the C-RNTI; a timing when the terminal device transmits a PUSCH transmission scheduled by the PDCCH transmission addressed to the C-RNTI; and a timing when the terminal device transmits a HARQ information corresponding to the PDSCH transmission addressed to the C-RNTI.

In a second aspect, there is provided a communication method implemented at a terminal device. The communication method comprises: transmitting, to a terminal device, a first configuration information on a first cell, wherein the first configuration information includes a set of transmission configuration indicator (TCI) states, and the set of TCI states is associated with a second cell different from the first cell; transmitting a first activation command to activate one or more TCI states, wherein the one or more TCI states comprise at least one TCI state from the set of TCI states; and applying the one or more activated TCI states from a first slot after a predefined timing.

In some examples, the method further comprises transmitting a second activation command to activate a subset of TCI states among the set of TCI states; and wherein transmitting the first activation command comprises transmitting the first activation command to activate the at least one TCI state among the subset of TCI states.

In a third aspect, there is provided a terminal device comprising: a processor; and a memory coupled to the processor and storing instructions thereon, the instructions, when executed by the processor, causing the terminal device to perform acts comprising the method according to any embodiments of the first aspect.

In a fourth aspect, there is provided a network device comprising: a processor; and a memory coupled to the processor and storing instructions thereon, the instructions, when executed by the processor, causing the network device to perform acts comprising the method according to any embodiments of the second aspect.

In a fifth aspect, there is provided a computer readable medium having instructions stored thereon, the instructions, when executed on at least one processor, causing the at least one processor to perform the method according to any embodiments of the first or second aspect.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method by a user equipment comprising:
receiving, from a network device on a first cell, configuration information,
wherein the configuration information includes a set of transmission configuration indicator (TCI) states, and the set of TCI states is associated with a second cell different from the first cell;
receiving an activation command to activate one or more TCI states,
wherein the one or more TCI states are from the set of TCI states; and
applying the one or more TCI states.

22. The method according to claim 21,
wherein the activation command is to activate one of the one or more TCI states for transmission on the second cell.

23. The method according to claim 21,
wherein the activation command is to activate two of the one or more TCI states for reception or transmission on the second cell.

24. The method according to claim 21,
wherein the activation command is received on a Physical Downlink Shared Channel (PDSCH).

25. The method according to claim 21,
wherein the one or more TCI states are applied after completion of a random access procedure on the second cell, or after a predefined duration after Hybrid Automatic Repeat reQuest Acknowledgement (HARQ-ACK) transmission in Physical Uplink Control Channel (PUCCH) corresponding the activation command.

26. The method according to claim 25,
wherein the predefined duration is 3 milli seconds.

27. The method according to claim 25,
wherein the predefined duration depends on a capability of the user equipment.

28. The method according to claim 21, further comprising:
wherein the activation command is a first activation command, and
wherein the one or more TCI states are first one or more TCI states,
receiving a second activation command to activate second one or more TCI states,
wherein the first one or more TCI states are from the second one or more TCI states.

29. A method by a network device comprising:
sending, to a user equipment on a first cell, configuration information,
wherein the configuration information includes a set of transmission configuration indicator (TCI) states, and the set of TCI states is associated with a second cell different from the first cell; and
sending an activation command to activate one or more TCI states,
wherein the one or more TCI states are from the set of TCI states.

30. The method according to claim 29,
wherein the activation command is to activate one of the one or more TCI states for transmission on the second cell.

31. The method according to claim 29,
wherein the activation command is to activate two of the one or more TCI states for reception and transmission on the second cell.

32. The method according to claim 29,
wherein the activation command is sent on a Physical Downlink Shared Channel (PDSCH).

33. The method according to claim 29,
wherein the one or more TCI states are applied after completion of a random access procedure on the second cell, or after a predefined duration after Hybrid Automatic Repeat reQuest Acknowledgement (HARQ-ACK) transmission in Physical Uplink Control Channel (PUCCH) corresponding the activation command.

34. The method according to claim 33,
wherein the predefined duration is 3 milli seconds.

35. The method according to claim 33,
wherein the predefined duration depends on a capability of the user equipment.

36. The method according to claim 29, further comprising:
wherein the activation command is a first activation command, and
wherein the one or more TCI states are first one or more TCI states,
sending a second activation command to activate second one or more TCI states,
wherein the first one or more TCI states are from the second one or more TCI states.

37. A user equipment comprising:
at least one memory; and
at least one hardware processor coupled to the at least one memory,
wherein the at least one hardware processor is configured to:
receive, from a network device on a first cell, configuration information,
wherein the configuration information includes a set of transmission configuration indicator (TCI) states, and the set of TCI states is associated with a second cell different from the first cell;
receive an activation command to activate one or more TCI states,
wherein the one or more TCI states are from the set of TCI states; and
apply the one or more TCI states.

38. A network device comprising:
at least one memory; and
at least one hardware processor coupled to the at least one memory,
wherein the at least one hardware processor is configured to:
send, to a user equipment on a first cell, configuration information,
wherein the configuration information includes a set of transmission configuration indicator (TCI) states, and the set of TCI states is associated with a second cell different from the first cell; and
send an activation command to activate one or more TCI states,
wherein the one or more TCI states are from the set of TCI states.
